(19) United States
(12) Patent Application Publication
(10) Pub. No.: US 2019/0005650 A1
(43) Pub. Date: Jan. 3, 2019

(54) PATTERN EDGE DETECTION METHOD

(71) Applicant: NGR Inc., Yokohama (JP)

(72) Inventor: Masahiro OYA, Yokohama (JP)

(21) Appl. No.: 16/018,810

(22) Filed: Jun. 26, 2018

(30) Foreign Application Priority Data
Jun. 29, 2017 (JP) 2017-127407

(51) Int. Cl. G06T 7/13; G06T 7/00

(52) U.S. Cl. CPC G06T 7/13; G06T 2207/30148; G06T 7/001; G06T 7/0006

(57) ABSTRACT

A method capable of accurately detecting an edge of a pattern on an upper layer and an edge of a pattern on a lower layer is disclosed. The pattern edge detection method includes: generating a sample image of an upper-layer pattern and a lower-layer pattern; applying a first image processing, which is for emphasizing an edge of the upper-layer pattern, to the sample image, thereby generating a first processed image; detecting the edge of the upper-layer pattern based on a brightness profile of the first processed image; applying a second image processing, which is for emphasizing an edge of the lower-layer pattern, to the sample image, thereby generating a second processed image; and detecting the edge of the lower-layer pattern based on a brightness profile of the second processed image.

### CROSS REFERENCE TO RELATED APPLICATION

This document claims priority to Japanese Patent Application No. 2017-127407 filed Jun. 29, 2017, the entire contents of which are hereby incorporated by reference.

### BACKGROUND

An optical pattern inspection apparatus, which uses a die-to-die comparison method, is used for a wafer pattern inspection in a semiconductor integrated circuit manufacturing process or for a pattern inspection of photomask that forms wafer patterns. The die-to-die comparison method is a technique of detecting a defect by comparing an image of a semiconductor device, which is referred to as a die to be inspected, with an image obtained at the same position in an adjacent die.

On the other hand, a die-to-database comparison method has been used for the inspection of a photomask (reticle) having no adjacent die. In this die-to-database comparison method, mask data are converted into an image. The image is then used for a substitution of the image of the adjacent die used in the die-to-die comparison method, and inspection is performed in the same manner as the above. The mask data are data obtained by applying photomask correction to design data (for example, see. U.S. Pat. No. 5,563,702).

However, when the die-to-database comparison method is used for wafer inspection, corner roundness of a pattern formed on a wafer is likely to be detected as a defect. In the inspection of a photomask, a smoothing filter is applied to an image, converted from the mask data, so as to form corner roundness, thereby preventing the corner roundness of the pattern from being detected as the defect. However, the corner roundness formed by the smoothing filter is different from corner roundness of each pattern actually formed on the wafer. As a result, the actual corner roundness can be detected as the defect. Therefore, an allowable pattern deformation quantity should be set in order to ignore such a difference in the corner roundness. However, this causes in turn a problem that a fine defect existing in a place except a corner cannot be detected.

From a viewpoint of problems in semiconductor integrated circuit fabrication, repeated defects (systematic defects) are more important issue than a random defect caused by a particle or the like. The repeated defects are defined as defects that occur repeatedly over all dies on a wafer caused by photomask failure, or the like. Because the repeated defects occur both in a die to-be-inspected and in adjacent dies that are to be compared with the die to-be-inspected, the die-to-die comparison wafer inspection cannot detect the repeated defects. Accordingly, the die-to-database comparison wafer inspection has been demanded.

The die-to-database comparison method is also effective in the inspection of a multilayer structure of patterns. In processing of a fine structure, it is essential to improve a positional accuracy of superimposing fine and complicated patterns formed on a layer onto patterns formed on an underlying layer. If the positional accuracy is low relative to a size of a pattern, a performance of a device is impaired. For this reason, in manufacturing of semiconductor devices, management of misalignment between layers, condition monitoring of manufacturing equipment, and feedback are carried out.

In many cases, the semiconductor inspection apparatus performs a misalignment inspection using a specific alignment pattern. However, an amount of misalignment may be different between the alignment pattern and a pattern that actually functions as a device. On the other hand, the die-to-database comparison method can inspect the misalignment with use of a pattern that actually functions as a device (for example, see “Gyoyeon Jo, et al, “Enhancement of Intrafield Overlay Using a Design based Metrology system”, SPIE 9778, Metrology, Inspection, and Process Control for Microlithography XXX, 97781J (Mar. 24, 2016); doi:10.1117/12.2218937”).

In an overlay inspection according to the die-to-database comparison method, edge detection of patterns on an upper layer and a lower layer may cause a problem. For example, when an upper pattern and a lower pattern overlap or come close to each other in a complicated manner, it is necessary to properly process design data so as not to detect an edge of the lower pattern covered by the upper pattern. U.S. Pat. No. 8,577,124 provides a method of detecting an edge excluding a region where patterns of an upper layer and a lower layer overlap.

However, as shown in FIG. 24, if an upper-layer pattern 1001 and a lower-layer pattern 1002 are close to each other, edges of these patterns may not be detected on an image generated by the scanning electron microscope. FIG. 25 is a schematic diagram showing an image of the upper-layer pattern 1001 and the lower-layer pattern 1002 shown in FIG. 24, and FIG. 26 is a graph showing a distribution of brightness values on a line segment x1-x2 shown in FIG. 25. Hereinafter, a one-dimensional graph showing a distribution of brightness values on a line segment drawn on an image will be called a brightness profile. In the brightness profile of FIG. 26, brightness values of the upper-layer pattern and the lower-layer pattern are continuous. As a result, positions of the edges of both patterns may not be determined.

### SUMMARY OF THE INVENTION

Therefore, according to embodiment, there is provided a method capable of accurately detecting an edge of a pattern on an upper layer and an edge of a pattern on a lower layer.

Embodiments, which will be described below, relate to a pattern edge detection method applicable to a semiconductor inspection apparatus that conducts a pattern inspection based on a comparison between pattern design data and a pattern image.

In an embodiment, there is provided a pattern edge detection method comprising: generating a sample image of an upper-layer pattern and a lower-layer pattern; applying a first image processing, which is for emphasizing an edge of the upper-layer pattern, to the sample image, thereby generating a first processed image; detecting the edge of the upper-layer pattern based on a brightness profile of the first processed image; applying a second image processing, which is for emphasizing an edge of the lower-layer pattern, to the sample image, thereby generating a second processed image; and detecting the edge of the lower-layer pattern based on a brightness profile of the second processed image.

In an embodiment, the first image processing is a tone-curve processing that emphasizes the edge of the upper-layer pattern, and the second image processing is a tone-curve processing that emphasizes the edge of the lower-layer pattern.

In an embodiment, the tone-curve processing applied to the first image processing is a process of lowering a brightness value at an intermediate level between a brightness value of the upper-layer pattern and a brightness value of the lower-layer pattern, and the tone-curve processing applied to the second image processing is a process of increasing the brightness value at the intermediate level between the brightness value of the upper-layer pattern and the brightness value of the lower-layer pattern.

In an embodiment, the pattern edge detection method further comprises: generating a template image from design data of the upper-layer pattern and the lower-layer pattern, the template image containing a first reference pattern corresponding to the upper-layer pattern and a second reference pattern corresponding to the lower-layer pattern; aligning the template image and the sample image with each other; drawing a first perpendicular line on an edge of the first reference pattern; and drawing a second perpendicular line on an edge of the second reference pattern, wherein the brightness profile of the first processed image is a distribution of brightness values of the first processed image on the first perpendicular line, and the brightness profile of the second processed image is a distribution of brightness values of the second processed image on the second perpendicular line.

In an embodiment, the pattern edge detection method further comprises applying a corner-rounding process to the first reference pattern and the second reference pattern.

In an embodiment, the pattern edge detection method further comprises: calculating a pattern shift representing a difference between a center of gravity of the upper-layer pattern on the sample image and a center of gravity of the first reference pattern; and calculating a pattern shift representing a difference between a center of gravity of the lower-layer pattern on the sample image and a center of gravity of the second reference pattern.

According to the above-described embodiments, the different two image processes are applied to the image, making edges of the upper-layer pattern and the lower-layer pattern sharp. Therefore, the respective edges of the upper-layer pattern and the lower-layer pattern can be accurately detected.

### BRIEF DESCRIPTION OF THE DRAWINGS

FIG. 1 is a schematic diagram showing an embodiment of an inspection apparatus;

FIG. 2 is a schematic diagram showing an embodiment of an image generating apparatus of the inspection apparatus;

FIG. 3 is a flowchart showing an embodiment of overlay inspection;

FIG. 4 is a schematic diagram of design data;

FIG. 5 is a template image generated from the design data;

FIG. 6 is a diagram for explaining corner-rounding process;

FIG. 7 is a diagram for explaining corner-rounding process;

FIG. 8 is a diagram showing a tone curve used in a first image processing;

FIG. 9 is a schematic diagram showing a part of a first processed image generated by applying the first image processing to a sample image;

FIG. 10 is a diagram showing a distribution of brightness values on a line segment x1-x2 shown in FIG. 9, i.e., a brightness profile;

FIG. 11 is a diagram showing a tone curve used in a second image processing;

FIG. 12 is a schematic diagram showing a part of a second processed image generated by applying the second image processing to the sample image;

FIG. 13 is a diagram showing a distribution of brightness values on a line segment x1-x2 shown in FIG. 12, i.e., a brightness profile;

FIG. 14 is a diagram showing origins of brightness profiles arranged on an edge of a first reference pattern on the template image;

FIG. 15 is a view showing perpendicular lines arranged on the edge of the first reference pattern;

FIG. 16 is a graph showing an example of the brightness profile;

FIG. 17 is a diagram for explaining an embodiment of edge detection;

FIG. 18 is a diagram showing an edge formed by sequentially connecting edge-detected positions on respective brightness profiles with lines;

FIG. 19 is a diagram showing an example in which a reference pattern, generated from design data, is not a closed polygon;

FIG. 20 is a sample image of two patterns;

FIG. 21 is a diagram showing design data of the patterns shown in FIG. 20;

FIG. 22 is a view showing bias lines extending between the patterns of FIG. 20 and origins of brightness profiles;

FIG. 23 is a diagram in which bias lines, corresponding to bias inspection values within a predetermined range, have been deleted;

FIG. 24 is a view showing an example in which an upper pattern and a lower pattern are located close to each other;

FIG. 25 is a schematic diagram showing an image of the upper pattern and the lower pattern shown in FIG. 24; and

FIG. 26 is a graph showing a distribution of brightness values on a line segment x1-x2 shown in FIG. 25.

### DESCRIPTION OF EMBODIMENTS

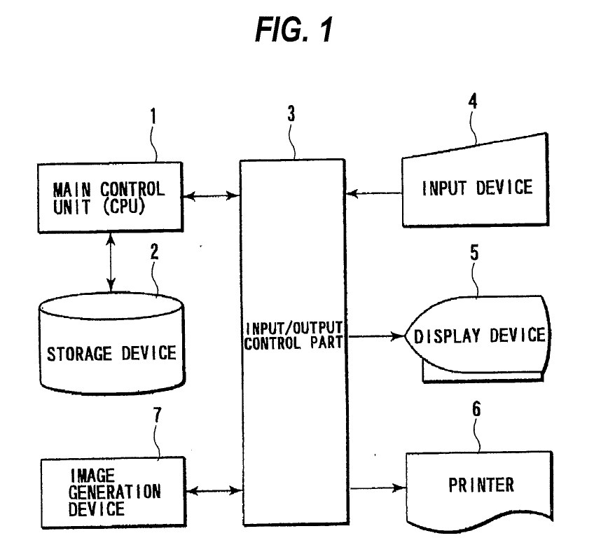

Hereafter, with reference to the drawings, embodiments will be described in detail. FIG. 1 is a schematic diagram showing an embodiment of an inspection apparatus. The inspection apparatus according to this embodiment comprises a main control unit 1, a storage device 2, an input/output control unit 3, an input device 4, a display device 5, a printer 6, and an image generation device 7.

The main control unit 1 comprises a CPU (Central Processing Unit), and manages and controls the whole apparatus. The main control unit 1 is coupled to the storage device 2. The storage device 2 may be in the form of a hard disk, a flexible disk, an optical disk, or the like. The input device 4 such as a keyboard and a mouse, the display device 5 such as a display for displaying input data, calculation results, and the like, and the printer 6 for printing the calculation results and the like are coupled to the main control unit 1 through the input/output control unit 3.

The main control unit 1 has an internal memory (internal storage device) for storing a control program such as an OS (Operating System), a program for the contact-hole inspection, necessary data, and the like. The main control unit 1 is configured to realize the contact-hole inspection and sampling point extraction with these programs. These programs can be initially stored in a flexible disk, an optical disk, or the like, read and stored in a memory, a hard disk, and the like before execution, and then executed.

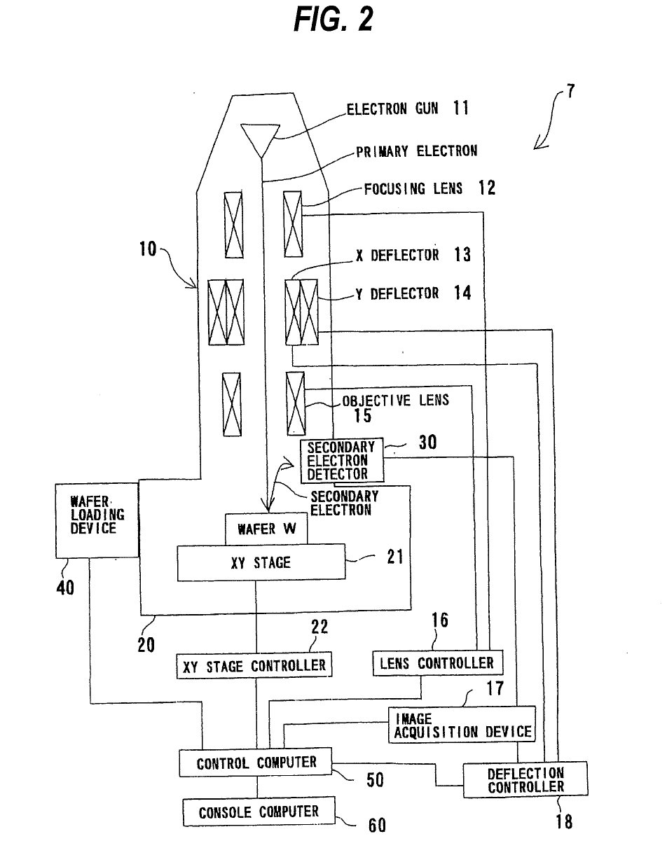

FIG. 2 is a schematic diagram of an embodiment of the image generation device 7 of the inspection apparatus. As shown in FIG. 2, the image generation device 7 includes an irradiation system 10, a specimen chamber 20, and a secondary electron detector 30. In this embodiment, the image generation device 7 comprises a scanning electron microscope.

The irradiation system 10 includes an electron gun 11, a focusing lens 12 for focusing primary electrons emitted from the electron gun 11, an X deflector 13 and a Y deflector 14 for deflecting an electron beam (charged-particle beam) in the X direction and the Y direction, respectively, and an objective lens 15. The specimen chamber 20 has an XY stage 21 which is movable in the X direction and the Y direction. A wafer W, which is a specimen, can be loaded into and unloaded from the specimen chamber 20 by a wafer-loading device 40.

In the irradiation system 10, primary electrons emitted from the electron gun 11 are focused by the focusing lens 12, deflected by the X deflector 13 and the Y deflector 14, and focused and applied by the objective lens 15 onto the surface of the wafer W which is a specimen.

When the primary electrons strike the wafer W, the wafer W emits secondary electrons. These secondary electrons are detected by the secondary electron detector 30. The focusing lens 12 and the objective lens 15 are coupled to a lens controller 16, which is coupled to a control computer 50. The secondary electron detector 30 is coupled to an image acquisition device 17, which is also coupled to the control computer 50. Intensities of the secondary electrons detected by the secondary electron detector 30 are converted into a voltage contrast image by the image acquisition device 17. A field of view is defined as the largest region where the primary electrons are applied and a voltage contrast image without distortion can be acquired.

The X deflector 13 and the Y deflector 14 are coupled to a deflection controller 18, which is also coupled to the control computer 50. The XY stage 21 is coupled to an XY stage controller 22. This XY stage controller 22 is also coupled to the control computer 50. The wafer-loading device 40 is also coupled to the control computer 50. The control computer 50 is coupled to a console computer 60.

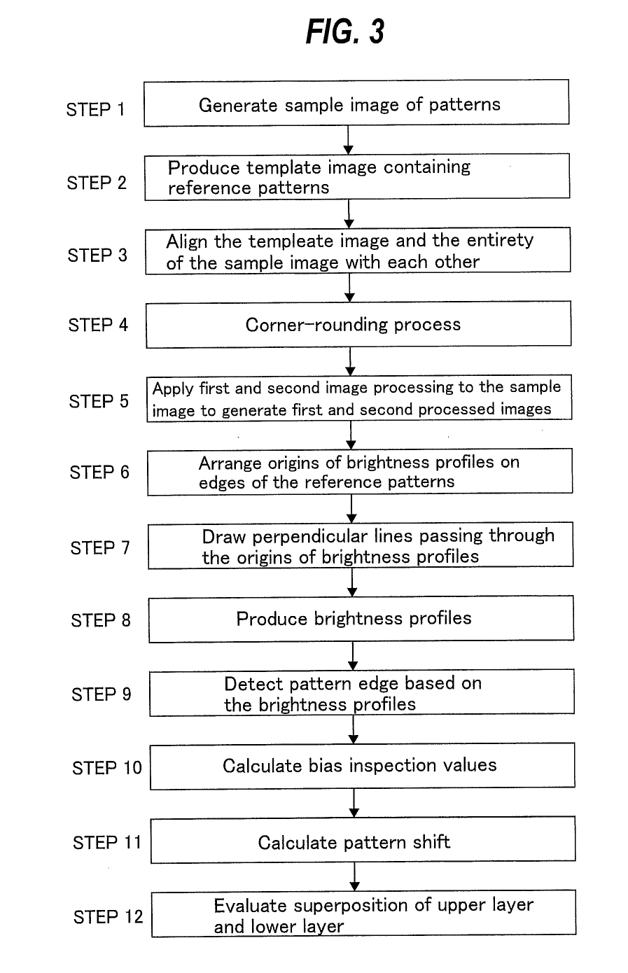

FIG. 3 is a flowchart showing an embodiment of an overlay inspection. The overlay inspection is executed by the main control unit 1 shown in FIG. 1. The image generating apparatus 7, composed of a scanning electron microscope, generates a sample image of an upper-layer pattern and a lower-layer pattern (step 1). In the present embodiment, the pattern on the upper layer and the pattern on the lower layer are formed on the surface of the wafer W which is a specimen.

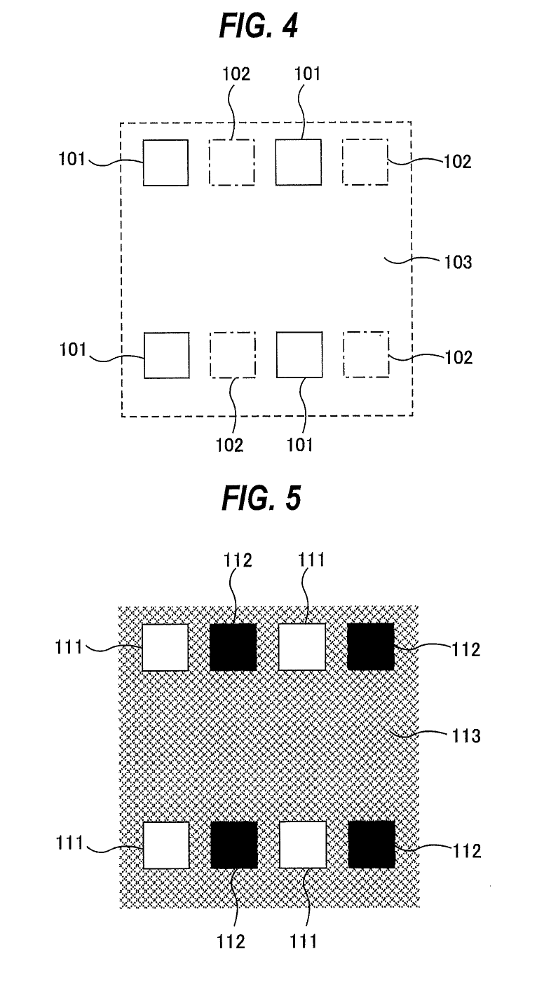

The main control unit 1 produces a template image containing a first reference pattern corresponding to the upper-layer pattern and a second reference pattern corresponding to the lower-layer pattern from design data of the upper-layer pattern and the lower-layer pattern described above (step 2). The design data is CAD data including information necessary for specifying a shape of a pattern, such as a size and vertex of each pattern, layer information to which each pattern belongs, and the like. The design data is stored in advance in the storage device 2 shown in FIG. 1. FIG. 4 shows a schematic diagram of the design data. In FIG. 4, reference numeral 101 denotes the upper-layer pattern, reference numeral 102 denotes the lower-layer pattern, and reference numeral 103 denotes a pattern background (a region where no pattern is formed).

The main control unit 1 produces the template image by coloring the background 103 on the design data gray, the upper-layer pattern 101 white, and the lower-layer pattern 102 black. FIG. 5 shows the template image generated from the design data. In FIG. 5, reference numeral 111 denotes a first reference pattern produced from the upper-layer pattern 101 of FIG. 4, reference numeral 112 denotes a second reference pattern produced from the lower-layer pattern 102 of FIG. 4, and reference numeral 113 denotes a pattern background (a region where no pattern is formed).

The main control unit 1 performs alignment of the template image and the entirety of the sample image generated in the step 1 (step 3 in FIG. 3). More specifically, the main control unit 1 performs the alignment by determining a relative position which results in the highest degree of coincidence between the template image and the sample image.

In a process of accessing the image based on the design data information, the main control unit 1 uses an offset obtained as a result of the alignment, i.e., an amount of misalignment between the template image and the sample image, in order to access information of a corresponding position.

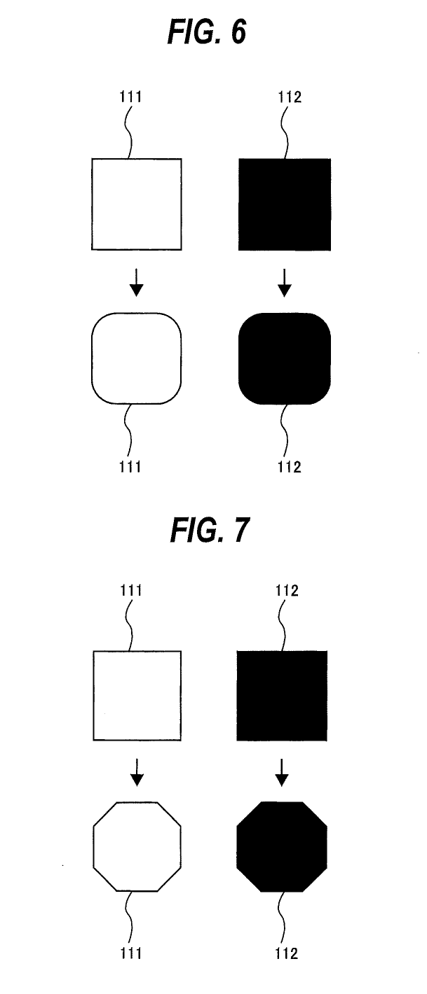

Next, the main control unit 1 performs a corner-rounding process on the reference patterns 111, 112 on the template image generated from the design data (step 4 in FIG. 3). In the present embodiment, as shown in FIG. 6, the main control unit 1 performs a corner-rounding process of replacing each corner of the reference patterns 111, 112 with a circular arc (i.e., a curved line). A radius of each circular arc can be preset. In one embodiment, as shown in FIG. 7, the main control unit 1 may perform a corner-rounding process of replacing each corner of the reference patterns 111, 112 with one or more line segments.

The main control unit 1 applies two different image processes, i.e., first image processing and second image processing, to the sample image to generate a first processed image and a second processed image (step 5 in FIG. 3). The first image processing is used for edge detection of the upper-layer pattern on the sample image, and the second image processing is used for edge detection of the lower-layer pattern on the sample image. More specifically, the first image processing is a tone-curve processing for emphasizing an edge of the upper-layer pattern on the sample image, and the second image processing is a tone-curve processing for emphasizing an edge of the lower-layer pattern on the sample image.

FIG. 8 is a diagram showing a tone curve used in the first image processing. The tone curve is a curved line showing a relationship between input brightness value of an image before the image processing is applied and output brightness value of the image after the image processing is applied. Specifically, the main control unit 1 converts an input brightness value represented on the horizontal axis into an output brightness value represented on the vertical axis, thereby changing the brightness of the sample image. Generally, the brightness is expressed with a numerical value ranging from 0 to 255. A broken line on the graph shown in FIG. 8 is a reference line segment on which the brightness is not changed.

As shown in FIG. 8, the tone curve used in the first image processing is curved downward. Therefore, a brightness value at an intermediate level is lowered. The upper-layer pattern appearing on the sample image is typically brighter than the lower-layer pattern. The brightness value of the pattern background is typically at an intermediate level between the brightness value of the upper-layer pattern and the brightness value of the lower-layer pattern. The first image processing is a processing operation for lowering a brightness value at an intermediate level between the brightness value of the upper-layer pattern and the brightness value of the lower-layer pattern on the sample image.

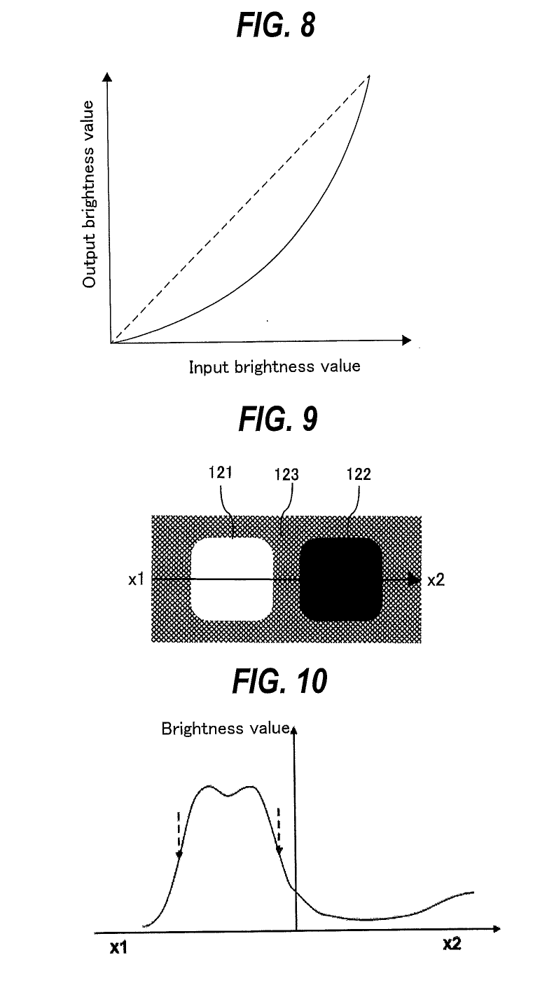

FIG. 9 is a schematic diagram showing a part of the first processed image generated by applying the first image processing to the sample image. As shown in FIG. 9, as a result of performing the first image processing on the sample image, the brightness values of the upper-layer pattern 121 and the lower-layer pattern 122 do not substantially change, while the brightness value of the background 123 decreases, i.e., the background 123 becomes dark. As a result, as can be seen from FIG. 9, the edge of the upper-layer pattern 121 is emphasized. FIG. 10 is a diagram showing a distribution of brightness values on a line segment x1-x2 shown in FIG. 9, i.e., a brightness profile. As can be seen from FIG. 10, the edge of the upper-layer pattern 121 is emphasized, making it easier to detect the edge.

FIG. 11 is a diagram showing a tone curve used in the second image processing. A broken line on the graph shown in FIG. 11 is a reference line segment on which the brightness is not changed. As shown in FIG. 11, the tone curve used in the second image processing is curved upward. Therefore, a brightness value at an intermediate level is increased. The second image processing is a processing operation for increasing a brightness value at an intermediate level between the brightness value of the upper-layer pattern and the brightness value of the lower-layer pattern on the sample image.

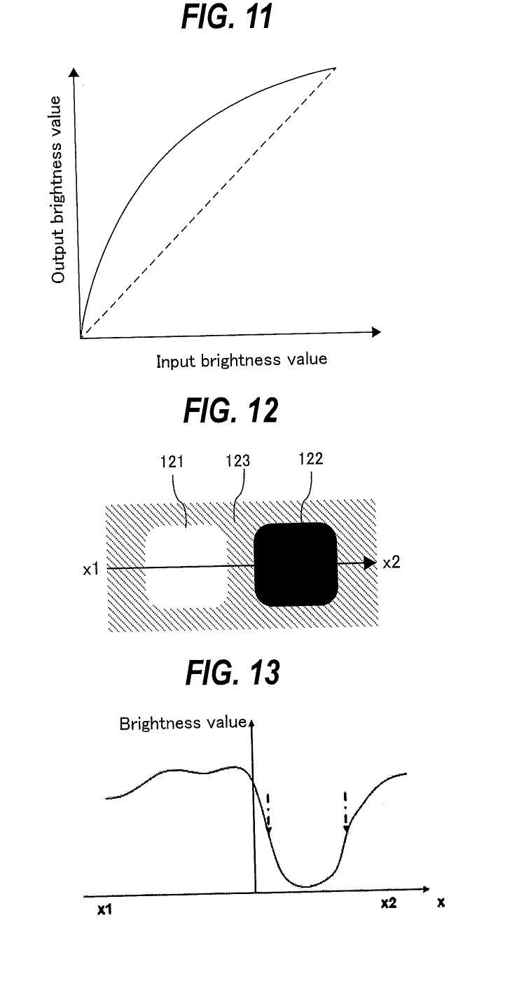

FIG. 12 is a schematic diagram showing a part of the second processed image generated by applying the second image processing to the sample image. As shown in FIG. 12, as a result of performing the second image processing on the sample image, the brightness values of the upper-layer pattern 121 and the lower-layer pattern 122 do not substantially change, while the brightness value of the background 123 increases, i.e., the background 123 becomes bright. As a result, as can be seen from FIG. 12, the edge of the lower-layer pattern 122 is emphasized. FIG. 13 is a diagram showing a distribution of brightness values on a line segment x1-x2 shown in FIG. 12, i.e., a brightness profile. As can be seen from FIG. 13, the edge of the lower-layer pattern 122 is emphasized, making it easier to detect the edge.

Steps, which will be described below, are processes for detecting the edge of the upper-layer pattern 121, while detection of the edge of the lower-layer pattern 122 is similarly performed. Therefore, duplicate explanations will be omitted.

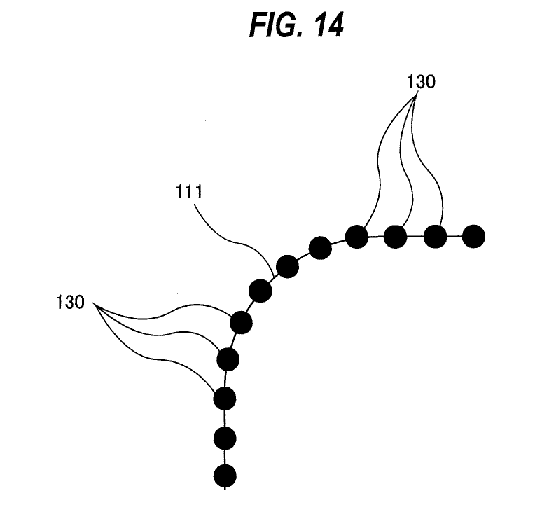

As shown in FIG. 14, the main controller 1 arranges origins 130 of brightness profiles at equal intervals on the edge of the first reference pattern 111 on the template image (step 6 in FIG. 3). A distance between adjacent origins 130 of the brightness profiles is, for example, a distance corresponding to one pixel size.

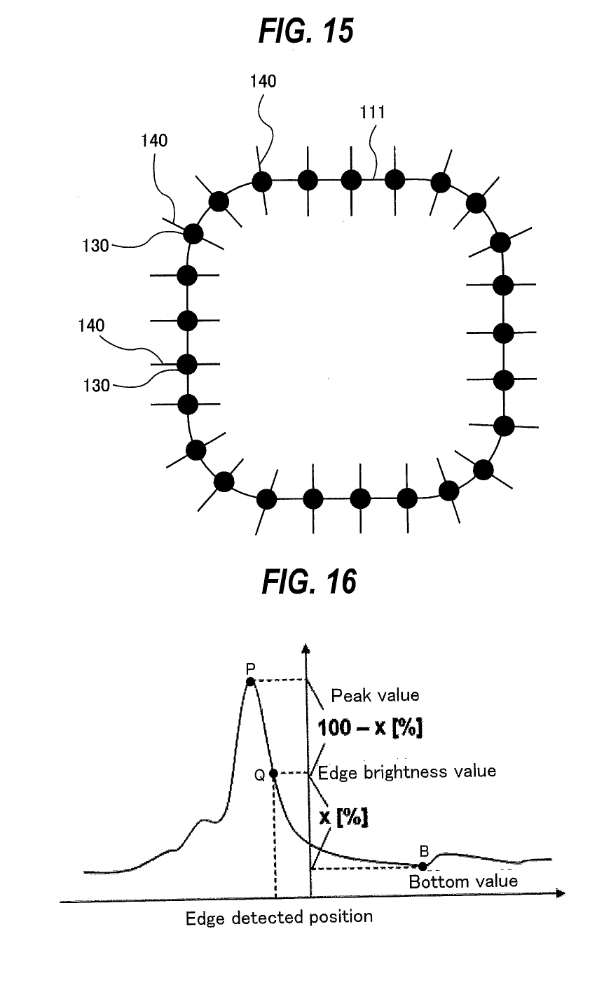

As shown in FIG. 15, the main control unit 1 draws perpendicular lines 140 passing through the origins 130 of the brightness profiles arranged in the step 6 (step 7 in FIG. 3). The perpendicular lines are line segments perpendicular to the edge of the first reference pattern 111 on the template image, and are arranged at equal intervals. The main control unit 1 obtains the brightness values of the first processed image (see FIG. 9) on each perpendicular line 140, and produces the brightness profile of the first processed image from these brightness values (step 8 of FIG. 3).

FIG. 16 is a graph showing an example of the brightness profile. In FIG. 16, a vertical axis represents the brightness value and a horizontal axis represents a position on the perpendicular line 140. The brightness profile represents the distribution of brightness values along the perpendicular line 140. The main control unit 1 detects the edge of the upper-layer pattern 121 (see FIG. 9) based on the brightness profile (step 9 in FIG. 3). For the edge detection, a threshold method, a linear approximation method, or other method is used. In the present embodiment, the threshold method is used to detect the edge.

The threshold method, which is one method of edge detection from the brightness profile, will be described with reference to FIG. 16. A threshold value is denoted by x [%]. The main control unit 1 determines a sampling point having the largest brightness value in the brightness profile, and designates a position of this sampling point as a peak point P. Next, the main control unit 1 determines a sampling point having the smallest brightness value in an outside-pattern area located more outwardly than the peak point P, and designates a position of this sampling point as a bottom point B. Next, the main control unit 1 determines an edge brightness value that internally divides brightness values, ranging from a brightness value at the bottom point B to a brightness value at the peak point P, into x: (100−x). This edge brightness value is located between the brightness value at the peak point P and the brightness value at the bottom point B. The main control unit 1 determines an edge-detected position which is a position of a sampling point Q on the brightness profile having the determined edge brightness value.

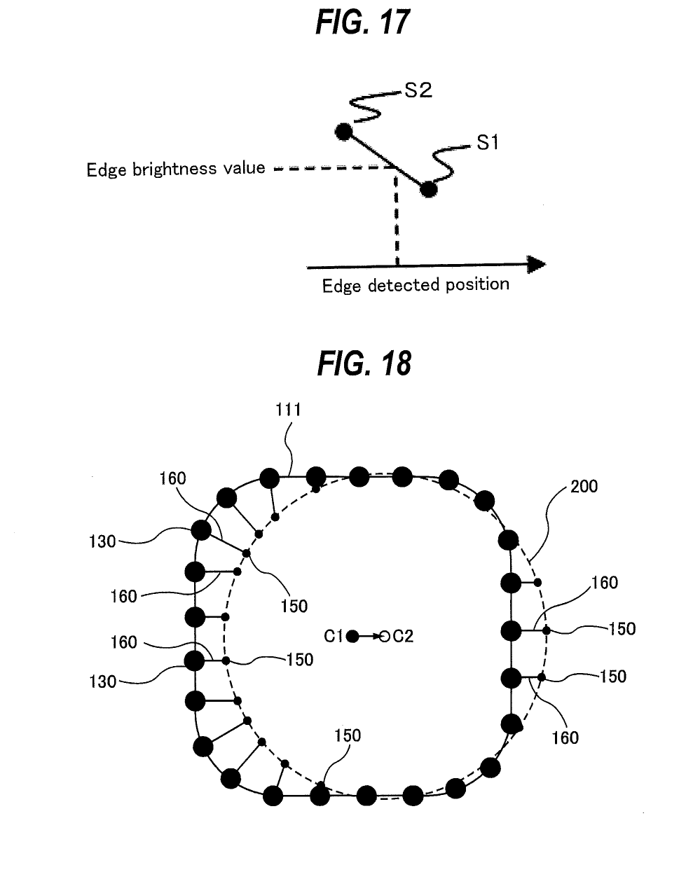

If the sampling point having the determined edge brightness value is not on the brightness profile, as shown in FIG. 17, the main control unit 1 searches brightness values of sampling points from the peak point P toward the bottom point B, determines a sampling point S1 at which the brightness value falls below the edge brightness value for the first time, and determines a sampling point S2 which is a neighboring point of the sampling point S1 at the peak-point side. The main control unit 1 then performs linear interpolation of the two sampling points S1, S2 to thereby determine an edge-detected position corresponding to the edge brightness value.

As shown in FIG. 18, the main control unit 1 sequentially connects edge-detected positions on respective brightness profiles with lines. In FIG. 18, reference numeral 150 denotes the above-described edge-detected position. Reference numeral 200 denotes an edge of the upper-layer pattern 121 (see FIG. 9) on the first processed image, which is composed of a plurality of edge-detected positions 150 connected by dotted lines. In this manner, the main control unit 1 can detect the edge of the upper-layer pattern on the sample image based on the brightness profiles.

In FIG. 18, a line segment connecting the profile origin 130 and the edge-detected position 150 is defined as a bias line 160. The main control unit 1 calculates a bias inspection value defined as a length of the bias line 160 extending from the edge-detected position 150 located outside the reference pattern 111. Further, the main control unit 1 calculates a bias inspection value defined as a value obtained by multiplying a length of the bias line 160 extending from the edge-detected position 150 located inside the reference pattern 111 by −1 (step 10).

In this way, the main control unit 1 can distinguish “thick deformation” and “thin deformation” of the upper-layer pattern 121 based on the bias inspection value. For example, a positive bias inspection value means that the pattern 121 is in a state of the thick deformation, and a negative bias inspection value means that the pattern 121 is in a state of the thin deformation. An upper limit and a lower limit may be predetermined for the bias inspection value. In this case, the main control unit 1 can detect a fat defect at which the bias inspection value exceeds the upper limit, and can also detect a thin defect at which the bias inspection value is lower than the lower limit.

In a case where the reference pattern 111 generated from the design data is an isolated pattern such as a hole or an island pattern, the edge 200 of the upper-layer pattern 121 formed from the plurality of edge-detected positions 150 constitutes a closed polygon. Therefore, the main control unit 1 can calculate the center of gravity C2 of the upper-layer pattern 121. Further, the main control unit 1 calculates a pattern shift which is a difference between the center of gravity C1 of the reference pattern 111 and the center of gravity C2 of the upper-layer pattern 121 (step 11). The pattern shift is represented by a vector specifying a distance and a direction from the center of gravity C1 of the reference pattern 111 to the center of gravity C2 of the upper-layer pattern 121.

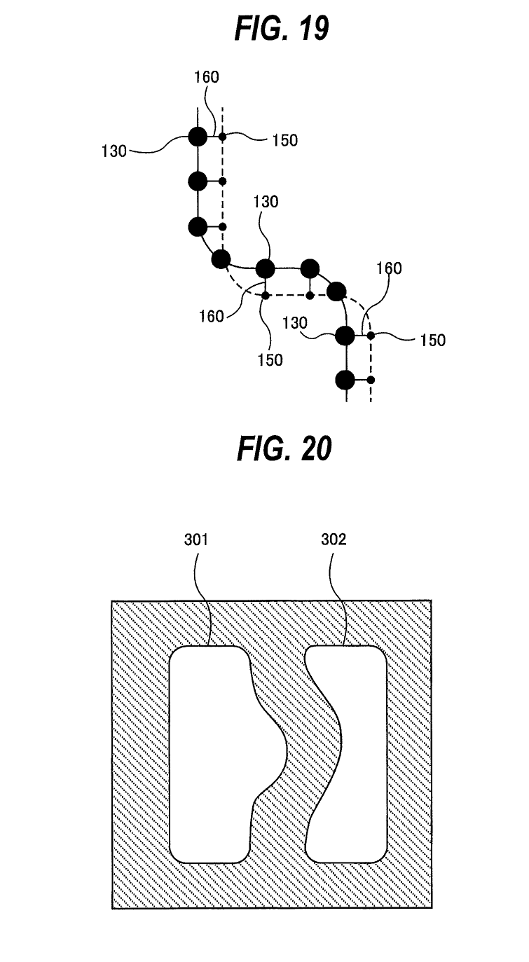

As shown in FIG. 19, even in a case where the reference pattern 111 generated from the design data is not a closed polygon, the main control unit 1 can determine a pattern shift from an angle and a direction of the bias line 160. For example, the main control unit 1 calculates a pattern shift in the X direction from a bias line 160 extending in the horizontal direction, calculates a pattern shift in the Y direction from a bias line 160 extending in the vertical direction, and can determine a pattern shift of the entirety of the upper-layer pattern 121 from the pattern shift in the X direction and the pattern shift in the Y direction.

Similarly, the main control unit 1 detects the edge of the lower-layer pattern 122 (see FIG. 12) on the second processed image by performing the step 6 to the step 9 on the second processed image. Further, the main control unit 1 calculates bias inspection values with respect to the lower-layer pattern 122 by performing the above-described step 10 and step 11, and further calculates a pattern shift which is a difference between the center of gravity of the second reference pattern 112 and the center of gravity of the lower-layer pattern 122.

The main control unit 1 aggregates pattern shifts of individual patterns, and evaluates the superposition of an upper layer and a lower layer (step 12). Specifically, the main control unit 1 calculates an average of pattern shifts of upper-layer patterns in an appropriate aggregation unit, and an average of pattern shifts of lower-layer patterns in the aggregation unit, and calculates a difference between these two averages. The appropriate aggregation unit may be all continuous patterns in one image or may be adjacent patterns.

The bias inspection values described above can represent deformation amounts of the upper-layer pattern and the lower-layer pattern on the sample image with respect to the reference patterns 111, 112. For example, if the calculated bias inspection value exceeds a predetermined range at a certain portion, the main control unit 1 can detect such a portion as a defect.

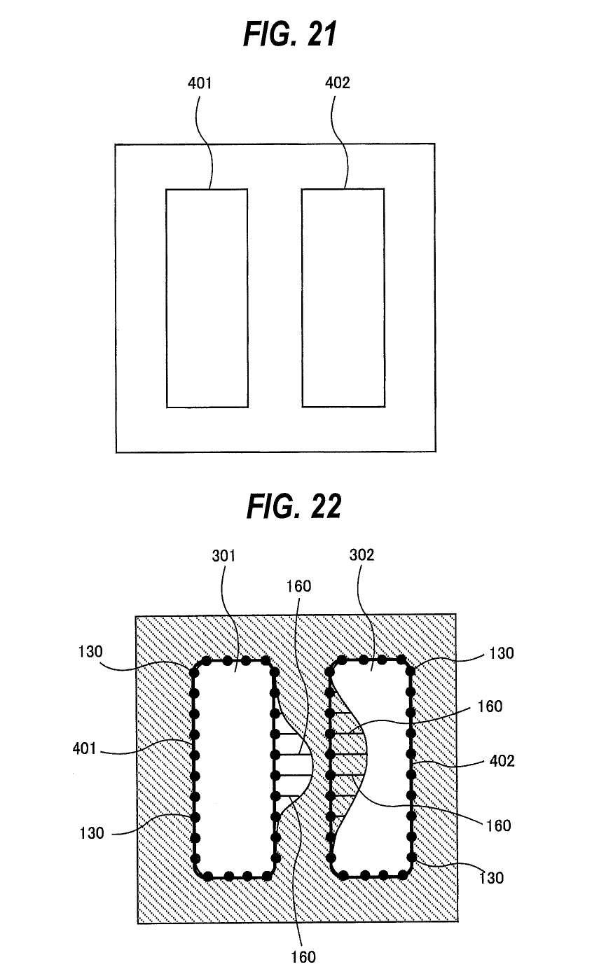

FIG. 20 shows a sample image of two patterns 301, 302, and FIG. 21 is a diagram showing design data of the patterns 301, 302 of FIG. 20. FIG. 22 shows bias lines 160 extending between the patterns 301, 302 and the origins 130 of the brightness profiles. The origins 130 of the brightness profiles are arranged at regular intervals on reference patterns 401, 402 (indicated by bold lines), which have been generated by applying the above-described corner-rounding process to design drawings of the patterns 301, 302.

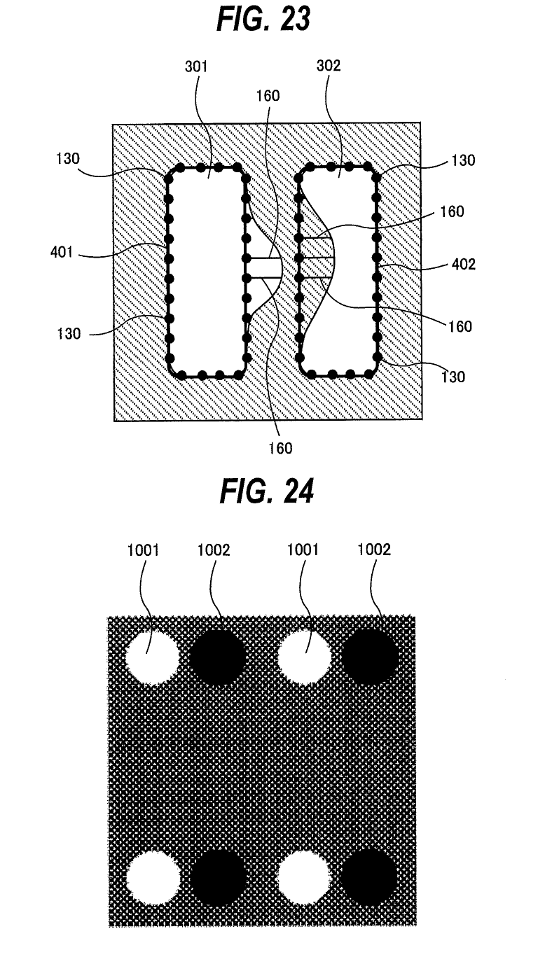

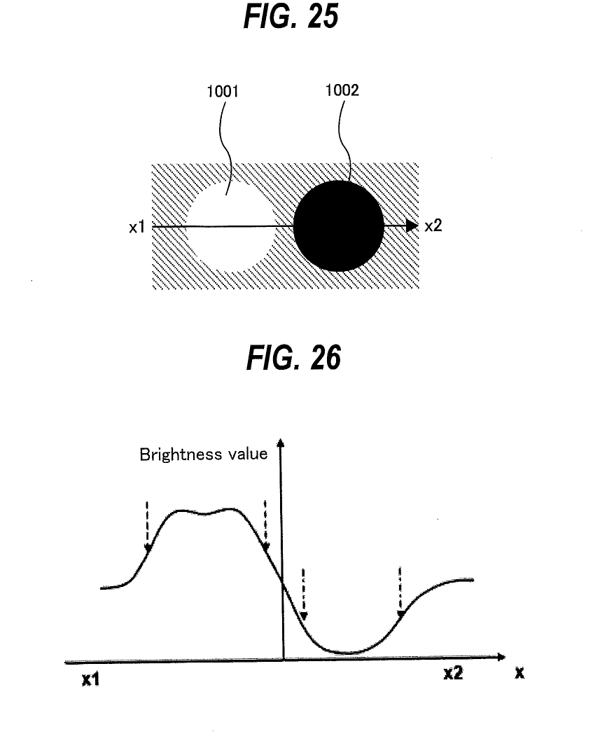

The lengths of the bias lines 160 are converted into bias inspection values described above. FIG. 23 is a diagram in which bias lines 160, corresponding to bias inspection values within a predetermined range, have been deleted. The main control unit 1 can detect defects which are represented by portions of the patterns 301, 302 where the bias lines 160 remain.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A pattern edge detection method comprising:
generating a sample image of an upper-layer pattern and a lower-layer pattern;
applying a first image processing, which is for emphasizing an edge of the upper-layer pattern, to the sample image, thereby generating a first processed image;
detecting the edge of the upper-layer pattern based on a brightness profile of the first processed image;
applying a second image processing, which is for emphasizing an edge of the lower-layer pattern, to the sample image, thereby generating a second processed image; and
detecting the edge of the lower-layer pattern based on a brightness profile of the second processed image.

2. The pattern edge detection method according to claim 1, wherein:
the first image processing is a tone-curve processing that emphasizes the edge of the upper-layer pattern; and
the second image processing is a tone-curve processing that emphasizes the edge of the lower-layer pattern.

3. The pattern edge detection method according to claim 2, wherein:
the tone-curve processing applied to the first image processing is a process of lowering a brightness value at an intermediate level between a brightness value of the upper-layer pattern and a brightness value of the lower-layer pattern; and
the tone-curve processing applied to the second image processing is a process of increasing the brightness value at the intermediate level between the brightness value of the upper-layer pattern and the brightness value of the lower-layer pattern.

4. The pattern edge detection method according to claim 1, further comprising:
generating a template image from design data of the upper-layer pattern and the lower-layer pattern, the template image containing a first reference pattern corresponding to the upper-layer pattern and a second reference pattern corresponding to the lower-layer pattern;
aligning the template image and the sample image with each other;
drawing a first perpendicular line on an edge of the first reference pattern; and
drawing a second perpendicular line on an edge of the second reference pattern,
wherein the brightness profile of the first processed image is a distribution of brightness values of the first processed image on the first perpendicular line, and
the brightness profile of the second processed image is a distribution of brightness values of the second processed image on the second perpendicular line.

5. The pattern edge detection method according to claim 4, further comprising:
applying a corner-rounding process to the first reference pattern and the second reference pattern.

6. The pattern edge detection method according to claim 4, further comprising:
calculating a pattern shift representing a difference between a center of gravity of the upper-layer pattern on the sample image and a center of gravity of the first reference pattern; and
calculating a pattern shift representing a difference between a center of gravity of the lower-layer pattern on the sample image and a center of gravity of the second reference pattern.
